(19) United States
(12) Patent Application Publication
(10) Pub. No.: US 2012/0015087 A1
(43) Pub. Date: Jan. 19, 2012

(54) FOOD PRESERVELATOR

(76) Inventors: John J. Cray, Lyndhurst, NJ (US); Maureen C. Cray, Lyndhurst, NJ (US)

(21) Appl. No.: 12/975,315

(22) Filed: Dec. 21, 2010

Related U.S. Application Data
(60) Provisional application No. 61/364,913, filed on Jul. 16, 2010.

(51) Int. Cl. A23L 3/00; B65D 81/20

(52) U.S. Cl. 426/418; 206/524.8

(57) ABSTRACT

An apparatus for the preservation and storage of perishable foods, the Food Preservelator prevents air from coming in contact with food, thus preventing decay and deterioration of the food. The invention may comprise a reusable, hard-shelled appliance into which food can be placed. On the door component of the invention may be a lever designed to lock the door shut, close and seal the front air vents and electrically activate a zero-pressure vacuum pump located on the back portion of the unit to extract air from inside the unit. When all of the air has been removed, the pump may automatically shut off. Vents on the front of the device can remain closed until opened by the door handle lever, which releases the vacuum within. A flexible gasket located around the entire perimeter of the door may be used to substantially guarantee a tight vacuum seal until the door and vents are opened via the door handle lever.

### CROSS-REFERENCE TO RELATED APPLICATION

The present application is related to and claims priority from prior provisional application Ser. No. 61/364,913, filed Jul. 16, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of food preservation and more specifically relates to a food preservelator for use in the preservation of perishable foods via vacuum means.

2. Description of the Related Art

Individuals in modern society may store their comestibles in various ways such that meals can be readily created upon demand. Perishable foods that need to be stored over a substantial period of time may need to be preserved. Food preservation is the process of treating and storing food to reduce spoilage including loss of quality, edibility or nutritive value caused or accelerated by micro-organisms. Maintaining or creating nutritional value, texture and flavor is important in preserving food's value. Preservation typically involves preventing the bacterial growth, fungi, and other micro-organisms, as well as retarding the oxidation of fats which may cause spoilage. This process tends to inhibit natural ageing and discoloration that can occur during food preparation. It is desirable to minimize food spoilage in an effort to lower household grocery expenses and to reduce health related issues potentially caused by such spoilage.

Some preservation methods require the food to be sealed after treatment to prevent recontamination with microbes. Food may be dried to be stored for long periods. Other suitable methods may include spray drying, freeze drying, freezing, vacuum-packing, pickling, canning, preserving in syrup, sugar crystallization, food irradiation, and adding preservatives or inert gases such as carbon dioxide to the food. The problem with most methods of food preservation is that changes in nutritional value, color, texture, and palatability commonly occur and the process for preservation can be costly when added to the original purchase price of the food. Most methods require the purchase of preservation agents, dry goods, and normally require considerable time to be invested with each preservation procedure. Existing vacuum bag sealing systems may require the use of plastic sealable bags which may also be costly when purchased. Thus, there exists a need for a quick, convenient, inexpensive method for preserving food.

Various attempts have been made to solve the above-mentioned problems such as those found in U.S. Pat. Nos. 7,571,748; 7,040,356; 5,806,575; 6,994,227; 7,677,165; 6,732,874; and 5,611,376. This prior art is representative of food preservation means and methods. None of the above inventions and patents, taken either singly or in combination, is seen to describe the invention as claimed.

Ideally, a food preservelator should be user-friendly and yet, would operate reliably and be manufactured at a modest expense. Thus, a need exists for a reliable vacuum container food storage system to preserve perishable foods and to avoid the above-mentioned problems.

### BRIEF SUMMARY OF THE INVENTION

In view of the foregoing disadvantages inherent in the known food storage and preservation art, the present invention provides a novel vacuum food preserver system. The general purpose of the present invention, which will be described subsequently in greater detail, is to provide low cost, quick, and convenient food storage.

A food preservation system is disclosed herein comprising: a food preservation appliance, having a housing, the housing having an inner volume and an enclosed shell frame. The shell frame may be shrouded with a vacuum sustainable material comprising a ferrous and/or non-ferrous material. The food preservation appliance further comprising a vented door with a plurality of apertures; a levered handle for slide-opening and/or closing the (front-facing) apertures; a sealing gasket for sealing the food preservation appliance; and at least one vacuum pump for evacuating the inner volume. In certain embodiments a cooling system may be manufactured integral with (within) food preservation appliance or alternately in communication with the food preservation appliance to coolingly-store the comestibles. The inner volume of the housing serves to store at least one comestible in a vacuum environment to promote preservation of the comestible(s) for an extended duration.

The apertures, when opened release the vacuum environment from the inner volume upon operation of the levered handle and the vacuum pump is deactivated upon opening of the apertures via operation of the levered handle. The levered handle may activate an electric cutout switch to deactivate the vacuum pump; wherein the plurality of apertures, when closed cause the vacuum pump to be activated via operation of the levered handle thereby evacuating the inner volume to create the vacuum environment. The vented door encloses and defines the inner volume and the sealing gasket serves to seal the vented door to the housing to maintain the vacuum environment. The vacuum pump evacuates and maintains the vacuum environment within the housing. Further, the vacuum pump is deactivated when the inner volume reaches a user-set negative pressure of between about 100 kPa to about 3 kPa or about 3 kPa to about 100 mPa (depending on user-preference) to preserve-store the comestible in the vacuum environment.

The food preservation system further comprises a kit, as described herein, including the food preservation appliance; an optional cooling system (or necessary plumbing/connections to use in combination with an existing cooling means) and a set of user instructions.

A method of operating a food preservation appliance is also disclosed herein at least comprising the steps of: opening a vented door to preservingly store at least one comestible within an inner volume; closing the vented door; and activating a vacuum pump to evacuate the inner volume of the food preservation appliance to non-perishably store the comestible(s). When the user wishes to retrieve the comestibles or to add to them he/she may open the door via the lever, whereby the vacuum is released. Once retrieved the door is shut and vacuum is restored. The steps may also include the device in combination with a cooling system for preserving comestibles requiring cooler temperature storage.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, the Food Preservelator, constructed and operative according to the teachings of the present invention.

FIG. 1 shows a perspective view illustrating a food preservation appliance entitled Food Preservelator according to an embodiment of the present invention.

FIG. 2 is a perspective view illustrating the food preservation appliance in an in-use condition according to an embodiment of the present invention of FIG. 1.

FIG. 3 is another perspective view illustrating the food preservation appliance according to an embodiment of the present invention of FIG. 1.

FIG. 4 is a perspective view illustrating the food preservation appliance according to another embodiment of the present invention of FIG. 1.

FIG. 5 is a flowchart illustrating a method of use for the food preservation appliance and system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a food preserving device and more particularly to a vacuum food preserver and storage device, the “Food Preservelator” as used to improve the speed, efficiency, and cost-effectiveness of preserving perishable foods.

Referring generally to the apparatus for the preservation and storage of perishable foods disclosed herein, the Food Preservelator prevents air from coming in contact with food, thus preventing decay and deterioration of the food. The invention may comprise a reusable, hard-shelled appliance into which food can be placed. On the door component of the invention may be a lever designed to lock the door shut, close and seal the front air vents and electrically activate a zero-pressure vacuum pump located on the back portion of the unit to extract air from inside the unit. When all of the air has been removed, the pump may automatically shut off. Vents on the front of the device can remain closed until opened by the door handle lever, which releases the vacuum within. A flexible gasket located around the entire perimeter of the door may be used to substantially guarantee a tight vacuum seal until the door and vents are opened via the door handle lever.

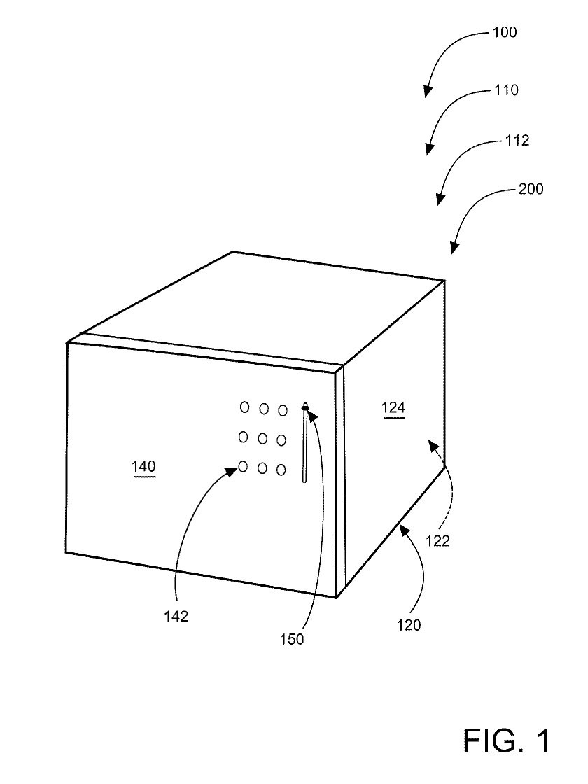

Referring now more specifically to the drawings by numerals of reference there is shown in FIG. 1, a perspective view illustrating food preservation appliance 110 entitled Food Preservelator 112 of food preservation system 100 according to an embodiment of the present invention.

The embodiment shown of food preservation appliance 110 in FIG. 1, as broadly disclosed herein preferably comprises: housing 120 having an inner volume 130; at least one vented door 140 having a levered handle 150; at least one sealing gasket 160; and at least one vacuum pump 170 for evacuating inner volume 130. Inner volume 130 of housing 120 serves to store at least one comestible 210 at a negative pressure (less than that of atmospheric pressure) to promote preservation of at least one comestible 210 for an extended duration. Vented door 140 in relation to housing 120 substantially encloses and defines inner volume 130. Sealing gasket 160 serves to seal vented door 140 to housing 120 such as to maintain negative pressure within housing 120, when desired. Vacuum pump 170 may be used to evacuate and maintains negative pressure within housing 120 by removably pumping air out of inner volume 130. Sealing gasket 160 maintains a seal to prevent higher pressure ambient air from re-entering and thus contaminating comestible 210 held within the confines of inner volume 130.

Housing 120 may comprise shell frame 122. Shell frame 122 is preferably shrouded with a vacuum sustainable material 124. Vacuum sustainable material 124 comprises stainless steel or other ferrous materials in certain embodiments. In these embodiments food preservation appliance 110 comprises aesthetically-pleasing, stain-resistant, and corrosion-resistant qualities. In other embodiments vacuum sustainable material 124 may comprise at least one composite, plastic, ceramic or other suitable material. It should be appreciated that a durable material that can withstand repeated tension and compression forces caused by pressurizing and de-pressurizing food preservation appliance 110 should be preferably used.

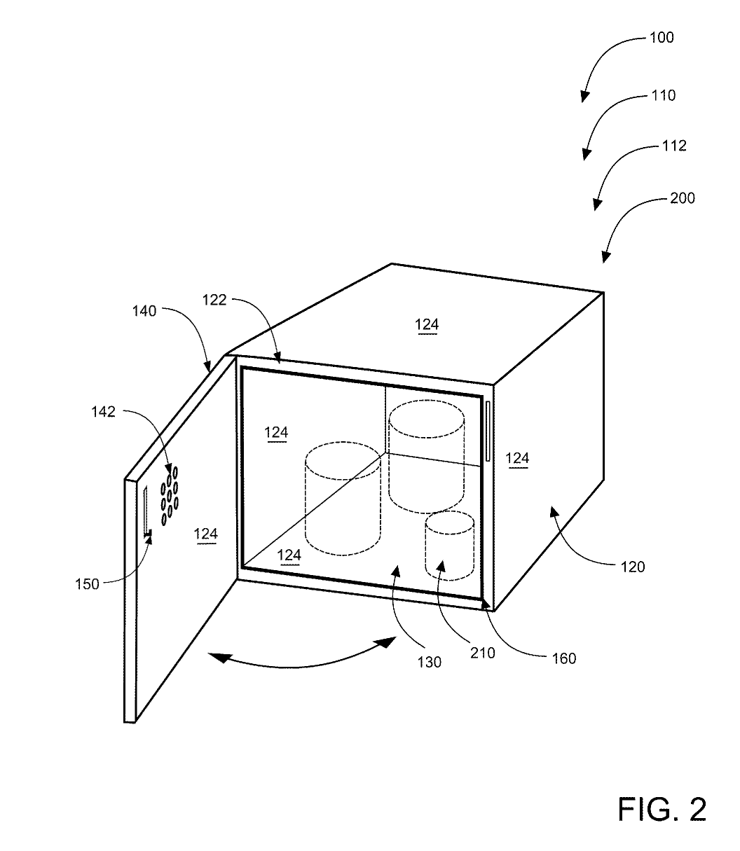

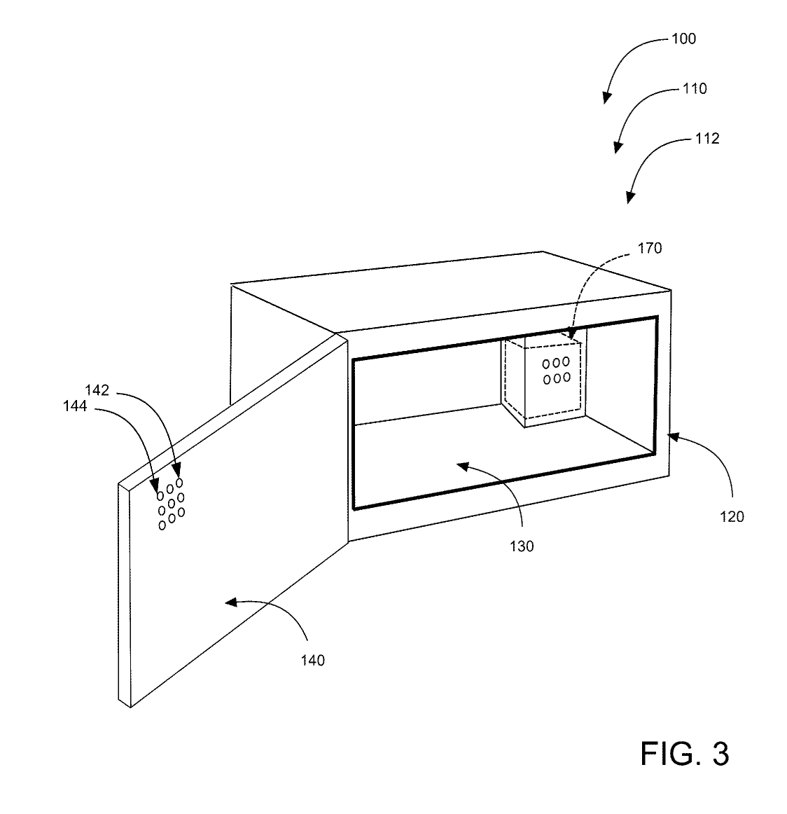

Referring now to FIGS. 2 and 3, perspective views illustrating food preservation appliance 110 in an in-use condition 200 (FIG. 2) according to embodiments of the present invention of FIG. 1.

Food preservation appliance 110 is shown in an in-use condition 200 in the present figure storing comestible 210 (shown in dotted lines). Comestible 210 may comprise various foodstuff(s), wherein comestibles 210 are storingly-preserved in the absence of air within inner volume 130. In-use condition 200 may comprise storing comestibles 210 within vacuum environment. User may manipulate levered handle 150 to open vented door 140 to access comestibles 210 and manipulate levered handle 150 and close vented door 140, causing vacuum pump 170 to be re-activated to reintroduce a vacuum environment condition.

Vented door 140, as shown, preferably comprises a plurality of apertures 142. Apertures 142 may comprise various shapes and sizes within the scope of the present invention. Apertures 142 in the present embodiment are preferably slidably-manipulatable (open/closeable) by a user-storer repeatably between open and closed conditions. In this way apertures 142 are directly or indirectly openable and closable via levered handle 150. When open, apertures 142 allow free-flow of ambient atmospheric pressure into inner volume 130 located within housing 120 of food preservation appliance 110. In this way the pressure is equalized with that of the ambient environment as airflows to the lesser pressurized zone. Apertures 142, when opened, release negative pressure from inner volume 130 upon operation of levered handle 150 in the manner described above. Levered handle 150 may comprise a locked and unlocked condition to substantially ensure that vacuum condition is not unknowingly compromised. Vacuum pump 170 is deactivated (via electrical or mechanical means) upon opening the plurality of apertures 142 via operation of levered handle 150. Apertures 142, when closed, cause vacuum pump 170 to be activated via operation of levered handle 150 thereby evacuating inner volume 130 to create negative pressure. As mentioned previously, sealing gasket 160 provides a seal (sealing means) between vented door 140 and housing 120 when apertures 142 are closed.

Vacuum pump 170 may be deactivated when inner volume 130 reaches a desired negative pressure of about 100 kPa to about 3 kPa, suitable to create a low vacuum. Alternately, vacuum pump 170 may be deactivated when inner volume 130 reaches said negative pressure of 3 kPa to 100 mPa, suitable to create a higher vacuum. In certain embodiments user is able to set vacuum to a user-preferred rating. Levered handle 150 may achieve this result via activating an electric cutout switch to deactivate vacuum pump 170.

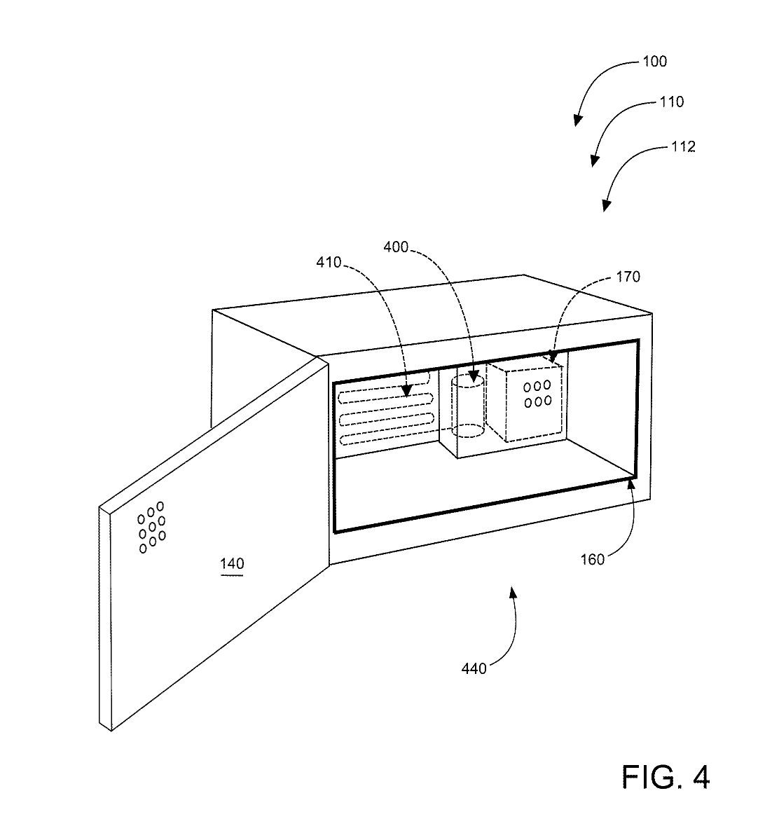

Referring now to FIG. 4, showing a perspective view illustrating food preservation appliance 110 according to another embodiment of the present invention of FIG. 1.

In certain embodiments food preservation appliance 110 comprises cooling coils 410 to store comestibles 210. Cooling coils 410 may be embedded in housing 120 and are thereby able to provide cooling means adjacent to comestibles 210. Within the embodiment shown in FIG. 4, food preservation system 100 comprises: food preservation appliance 110, having housing 120. Housing 120 has an inner volume 130 and an enclosed shell frame 122 including cooling coils 410. Shell frame 122 is shrouded with vacuum sustainable material 124 comprising a ferrous and/or non-ferrous material; at least one vented door 140 with a plurality of front-facing apertures 144; a levered handle 150 for slide-opening and/or closing front-facing apertures 144; at least one sealing gasket 160 for sealing food preservation appliance 110; and at least one vacuum pump 170 for evacuating inner volume 130. Front-facing apertures 144 may be used within this particular embodiment as versus side or back oriented versions to avoid cooling coils 410.

Comestibles 210 that are typically stored in refrigerators may need to be stored in cooled conditions, even if in vacuum environment. Accordingly in certain embodiments food preservation appliance 110 may be stored in a cooled environment. In alternate embodiments cooling system 400 may be included and enclosed within housing 120 or others may be in communication with food preservation appliance 110 to store comestibles 210. In these embodiments inner volume 130 of housing 120 serves to store at least one comestible 210 in a sufficiently cooled vacuum environment to promote preservation of at least one comestible 210 for an extended duration in an temperature-controlled environment much like that of a refrigerator ranging from 3 to 5° C. (37 to 41° F.). In these versions housing 120 may comprise insulating means. Those with ordinary skill in the art will now appreciate that upon reading this specification and by their understanding the art of food preservation as described herein, methods of manufacturing and using such food preservers will be understood by those knowledgeable in such art.

As in other embodiments, front-facing apertures 144 (apertures 142), when opened release vacuum environment from inner volume 130 upon operation of levered handle 150. Vacuum pump 170 may be deactivated upon opening of front-facing apertures 144 via operation of levered handle 150. Levered handle 150 may be located in vented door 140, as shown, and may activate an electric cutout switch to deactivate vacuum pump 170. As aforementioned, front-facing apertures 144, when closed preferably cause vacuum pump 170 to be activated via operation of levered handle 150 thereby evacuating inner volume 130 to create the vacuum environment. Vented door 140 encloses and defines inner volume 130 within food preservation appliance 110. Sealing gasket 160 which preferably comprises rubber or other suitably pliable material serves to seal vented door 140 to housing 120 to maintain the chilled vacuum environment within housing 120. Sealing gasket 160 and closed front-facing apertures 144 (and closed vented door 140) serve to contain cool temperature in inner volume 130. Cooling system 400 may comprise a condenser, an evaporator, a compressor, and fan(s) or be attached or in communication with food preservation appliance 110. Vacuum pump 170 evacuates and maintains vacuum environment within housing 120. Vacuum pump 170 may be deactivated when inner volume 130 reaches a user-set negative pressure of between about 100 kPa to about 3 kPa (low vacuum) or 3 kPa to 100 mPa (medium vacuum) to preserve-store comestible 210 in the vacuum environment. In this way perishable comestibles 210 may be effectively prevented from spoiling.

The food preservation system 100 may comprise a kit 440 including food preservation appliance 110; and a set of user instructions (not shown). The Food Preservelator 112 may be manufactured and provided for sale in a wide variety of sizes and shapes for a wide assortment of applications including refrigerated versions and non-refrigerated versions. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, parts may be sold separately, etc., may be sufficient.

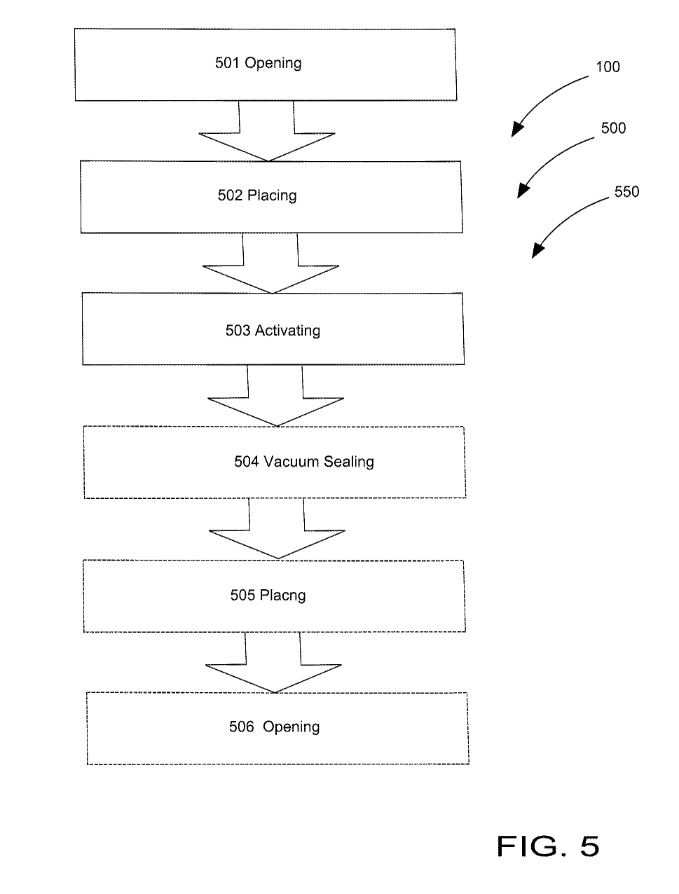

Referring now to FIG. 5, a flowchart 550 illustrating a method of use 500 for food preservation appliance 110 and food preservation system 100 according to embodiment(s) of the present invention of FIGS. 1-4.

A method of use 500 for operating food preservation appliance 110 preferably comprises the steps of: step one 501 opening vented door 140 to store at least one comestible 210 within inner volume 130; step two 502 placing comestible 210 in inner volume 130 and closing vented door 140; and step three 503 activating at least one vacuum pump 170 to evacuate inner volume 130 of food preservation appliance 110 to non-perishably store comestible(s) 210. Method of use 500 may further optionally comprise step four 504 comprising vacuum sealing and self-cooling inner volume 130 and/or step five 505 placing food preservation appliance 110 in communication with cooling system 400. Step six 506 opening food preservation appliance 110 to retrieve stored comestible 210.

It should be noted that steps 504, 505 and 506 are optional steps and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A food preservation appliance comprising:
a housing having an inner volume;
at least one vented door having a levered handle;
at least one sealing gasket;
at least one vacuum pump for evacuating said inner volume;
wherein said inner volume of said housing serves to store at least one comestible at a negative pressure, less than that of atmospheric pressure to promote preservation of said at least one comestible for an extended duration;
wherein said vented door encloses said inner volume and said at least one sealing gasket serves to seal said vented door to said housing to maintain said negative pressure within said housing; and
wherein said vacuum pump evacuates and maintains said negative pressure within said housing.

2. The food preservation appliance of claim 1 wherein said housing comprises a shell frame.

3. The food preservation appliance of claim 2 wherein said shell frame is shrouded with a vacuum sustainable material.

4. The food preservation appliance of claim 3 wherein said vacuum sustainable material comprises stainless steel.

5. The food preservation appliance of claim 3 wherein said vacuum sustainable material comprises at least one composite.

6. The food preservation appliance of claim 1 wherein said vented door comprises a plurality of apertures.

7. The food preservation appliance of claim 6 wherein said plurality of apertures are openable and closable via said levered handle.

8. The food preservation appliance of claim 7 wherein said plurality of apertures, when opened release said negative pressure from said inner volume upon operation of said levered handle.

9. The food preservation appliance of claim 8 wherein said vacuum pump is deactivated upon opening of said plurality of apertures via operation of said levered handle.

10. The food preservation appliance of claim 7 wherein said plurality of apertures, when closed cause said vacuum pump to be activated via operation of said levered handle thereby evacuating said inner volume to create said negative pressure.

11. The food preservation appliance of claim 7 wherein said sealing gasket provides a seal between said vented door and said housing when said plurality of apertures are closed.

12. The food preservation appliance of claim 10 wherein said vacuum pump is deactivated when said inner volume reaches said negative pressure of 100 kPa to 3 kPa.

13. The food preservation appliance of claim 10 wherein said vacuum pump is deactivated when said inner volume reaches said negative pressure of 3 kPa to 100 mPa.

14. The food preservation appliance of claim 9 wherein said levered handle activates an electric cutout switch to deactivate said vacuum pump.

15. The food preservation appliance of claim 1 wherein said food preservation appliance comprises cooling coils to store said comestibles.

16. A food preservation system comprising:
a food preservation appliance,
having a housing, said housing having an inner volume and an enclosed shell frame;
said shell frame is shrouded with a vacuum sustainable material comprising a ferrous and/or non-ferrous material;
at least one vented door with a plurality of front-facing apertures;
a levered handle for slide-opening and/or closing said front-facing apertures;
at least one sealing gasket for sealing said food preservation appliance;
at least one vacuum pump for evacuating said inner volume;
a cooling system within or in communication with said food preservation appliance to coolingly-store said comestibles;
wherein said inner volume of said housing serves to store at least one comestible in a vacuum environment to promote preservation of said at least one comestible for an extended duration;
wherein said plurality of front-facing apertures, when opened release said vacuum environment from inner volume upon operation of said levered handle;
wherein said vacuum pump is deactivated upon opening of said plurality of front-facing apertures via operation of said levered handle, said levered handle activates an electric cutout switch to deactivate said vacuum pump;
wherein said plurality of front-facing apertures, when closed cause said vacuum pump to be activated via operation of said levered handle thereby evacuating said inner volume to create said vacuum environment;
wherein said vented door encloses and defines said inner volume and said at least one sealing gasket serves to seal said vented door to said housing to maintain said vacuum environment within said housing;
wherein said vacuum pump evacuates and maintains said vacuum environment within said housing; and
wherein said vacuum pump is deactivated when said inner volume reaches a user-set negative pressure of between about 100 kPa to about 3 kPa or about 3 kPa to about 100 mPa to preserve-store said comestible in said vacuum environment.

17. The food preservation system of claim 16 further comprises a kit including said food preservation appliance; and a set of user instructions,

18. A method of operating a food preservation appliance comprising the steps of:
opening a vented door to preservingly store at least one comestible within an inner volume;
closing said vented door; and
activating a vacuum pump to evacuate said inner volume of said food preservation appliance to non-perishably store said comestible.

19. The method of operating a food preservation appliance of claim 18 further comprising the step of self-cooling said inner volume.

20. The method of operating a food preservation appliance of claim 18 further comprising the step of placing said food preservation appliance in communication with a cooling system.
